(19) United States
(12) Patent Application Publication
(10) Pub. No.: US 2014/0011620 A1
(43) Pub. Date: Jan. 9, 2014

(54) DRIVE DEVICE FOR DRIVING A WHEEL OF A SPRING STRUT-TYPE AXLE FOR AN ELECTRICALLY DRIVABLE VEHICLE

(71) Applicants: Martin Munster, Munchen-Laim (DE); Stephan Pollmeyer, Friedrichshafen (DE); Jens Heimann, Stetten (DE)

(72) Inventors: Martin Munster, Munchen-Laim (DE); Stephan Pollmeyer, Friedrichshafen (DE); Jens Heimann, Stetten (DE)

(73) Assignee: ZF Friedrichshafen AG, Friedrichshafen (DE)

(21) Appl. No.: 14/004,742

(22) PCT Filed: Feb. 1, 2012
(86) PCT No.: PCT/EP2012/051641

§ 371 Date: Sep. 12, 2013

(30) Foreign Application Priority Data
Mar. 16, 2011 (DE) 102011005623.8

(51) Int. Cl. B60K 7/00

(52) U.S. Cl. CPC B60K 7/0007
USPC 475/149

(57) ABSTRACT

A drive device (1) for driving a wheel (2) of a spring strut axle for an electrically driven vehicle. The drive device has an electric machine (3) and a transmission unit, and the transmission unit has a spur gear transmission (5) and a planetary transmission (4) which, viewed in the direction of the flow of force in traction operation, is positioned at the output side of the electric machine (3) in the sequence of from the electric machine (3) to the planetary transmission (4) and then to the spur gear transmission (5).

This application is a National Stage completion of PCT/EP2012/051641 filed Feb. 1, 2012, which claims priority from German patent application serial no. 10 2011 005 623.8 filed Mar. 16, 2011.

### FIELD OF THE INVENTION

The invention concerns a drive device for driving a wheel of a spring strut axle for an electrically driven vehicle.

### BACKGROUND OF THE INVENTION

Generally, the configuration of the drive train in electrically driven vehicles corresponds to the drive trains of vehicles which have a central drive, comprising of a combustion engine. Herein, a drive device which comprises an electric machine, a transmission, and a differential, is fixed in position at the center of the chassis in the vehicle, between the front and the rear wheels; the drive torque is, like in conventional central drives, transferred to the driven wheels via side shafts. In such a configuration of the drive train, the concept of the chassis is mostly maintained, wherein only modifications of the aggregate bearing and the auxiliary frame are required.

In an electrically driven or drivable vehicle which comprises a central drive, to accommodate the battery requires a significant modification of the structure of the vehicle. It is hereby known to integrate the battery with the subfloor, for instance under the rear seat or in the area which was occupied by the transmission duct in central drives with a combustion engine.

Electric drives which are arranged near the wheel are also known in the state of the art, wherein drives close to the wheel are understood to be drives which have one or more electric motors for each driven wheel of the vehicle. Therefore, vehicles are known with two or more driven wheels which has a corresponding number of drives, meaning two or more. Hereby, an electric motor can precisely drive a driven wheel.

Also, drives near the wheels are known in the state-of-the-art to drive a wheel of a driven axle for electrically driven vehicles which are integrated into the chassis of the vehicle whereby, depending on the number of driven axles of the vehicle, for instance two or four electric drives are provided.

Hereby, the electric drives can be fixed in position at the wheels; in which case the electric drive is elastically supported directly together with the wheel and the unsuspended mass is directly influenced by the drive.

Another possibility includes positioning the electric drives close to the wheel in a chassis-fixed construction. Hereby, the electric drives move from the vehicle center towards the wheels. They are hereby attached to the chassis and do not influence the unsuspended masses.

Also, the electric drives can be fixed in position at suspension rods where in this case, they are attached to the chassis suspension rods, for instance at the torsion rods. In this concept, the unsuspended mass is reduced through the positioning of the electric drives close to the chassis-fixed connection point of the suspension rods.

Drives which are near the wheel can be utilized in an all-wheel, front, or rear drive, wherein the type of axles of the driven vehicle axles can be conventional types of axles such as spring strut or dual wishbone axle types. Also, drives which are near the wheel can be part of a wheel integrated chassis.

Also, the electric drives near the wheel can have a transmission.

Known through WO 2008/017945 A1 is a drive device for driving a wheel which can be integrated into the wheel of the vehicle, which has an electric motor and a transmission unit, whereby the transmission unit has a spur gear transmission and a planetary transmission which are configured in series. Hereby, the planetary transmission is, viewed in the direction of the flow of force in traction operation, positioned at the output side down from the spur gear transmission.

In an advantageous manner, the application of electric drives which are near the wheel, for driving a wheel of a driven axle, result in a high flexibility during the vehicle construction because, due to the elimination of the central drive and the center of the vehicle, new degrees of freedom arise during the design of the vehicle, in particular during the design of the inner passenger space of the vehicle, the battery accommodation, and the crash safety.

Furthermore, electric drives arranged near the wheels can create wheel-specific drive torques, which allows functions such as torque vectoring, ESP, ABS, ASR, etc. to be realized in a simple way. Through the fast and accurate control of electric drives, these functions can be optimized in comparison to the traditional brake based control systems.

### SUMMARY OF THE INVENTION

The present invention has the task of proposing a drive device for driving a wheel of a spring strut axle for an electrically driven vehicle.

Thus, a drive device for driving a wheel of a spring strut axle for an electrically driven vehicle is proposed which comprises of an electric machine and a transmission unit, wherein the transmission unit has a spur gear transmission and a planetary transmission which, viewed in the direction of the flow of force in the traction operation, are positioned at the output side of the electric machine in the sequence of planetary transmission-spur gear transmission.

The planetary transmission is coaxially positioned in reference to the rotor of the electric machine, wherein the spur gear transmission is positioned axially parallel to the rotor of the electric machine. The drive device is positioned axial parallel to the axle of the wheel.

The axle offset which is created through this concept is preferably used to position the drive device, viewed in the forward direction, before the center of the wheel, meaning at the vertical center plane of the wheel which faces away from the tie rod, which allows the integration into a tight mounting space; a positioning of the drive device, viewed in the forward direction, behind the center of the wheel is also possible if there is sufficient distance to the tie rod and the brake caliper is provided in a mirrored position to the vertical center plane of the wheel.

Through the combination of a planetary transmission with a spur gear transmission, a large gear ratio is made possible whereby the dimensions, as well as the weight of the electric machine, thus the unsuspended masses, can be kept low; for instance, the achievable gear ratio with these two transmissions, meaning the ratio between the rotational speed of the input shaft of the two transmissions in relationship to the rotational speed of the output shaft of both transmissions, can become a value which is larger than 10. The gear ratio preferably assumes the value 16. Hereby, the spread of the achievable gear ratios to the transmissions can be symmetric or asymmetric.

A combination of low drive torque with the use of large rotational speeds creates in an advantageous manner, in connection with the two planetary transmissions of the drive device, a large power/weight ratio (kW/kg). A smaller electric machine can be used which allows or rather simplifies, in an advantageous manner, integrating the electric machine into the wheel carrier.

An housing of the drive device can serve as a wheel carrier, or as a part of the wheel carrier, and can pass created forces into the chassis.

Preferably, the positioning of the electric machine and the transmission unit is done in a way that, in the main operating position of the vehicle, the lubricant, affected by gravity, flows back by itself from the electric machine into the oil sump of the transmission chamber, wherein the housing of the electric machine is designed for this purpose in such a way that sufficient lubrication of the bearing of the rotor shaft is guaranteed. This creates the advantage that the provision of contacting or non-contacting gaskets, in particular in fast rotating shafts of the drive device, can be omitted, whereby the losses of lubricant and the creation of heat can be reduced.

It is proposed in the framework of a further embodiment of the invention to directly connect the housing of the drive device with the wheel carrier of the spring strut, for instance to screw it together, to integrate it as a multi-part welded component into the wheel carrier or design it as one part with the wheel carrier.

In the framework of an additional embodiment, the electric machine and the planetary transmission can have a common housing.

In addition, the connection of the brake caliper, in the case of a disc brake and/or the damper and/or the spring, can be integrated with a housing of the drive device, whereby the connecting screws for fixing the brake caliper can at the same time be the housing screws for attaching the drive device at the trailing link of the axle.

Thus, a compact construction can be achieved and there is no requirement for separate parts which results in a reduction of the cost.

### BRIEF DESCRIPTION OF THE DRAWINGS

In the following, the invention is further explained based on the attached drawings, wherein the same reference characters are used for the same parts. These show:

FIG. 1 a schematic sectional view of an embodiment of an inventive drive device for an electrically driven vehicle and the positioning of the drive device; and

FIG. 2 the sectional view of the arrangement of a drive device in accordance with the invention.

### DETAILED DESCRIPTION OF THE PREFERRED EMBODIMENTS

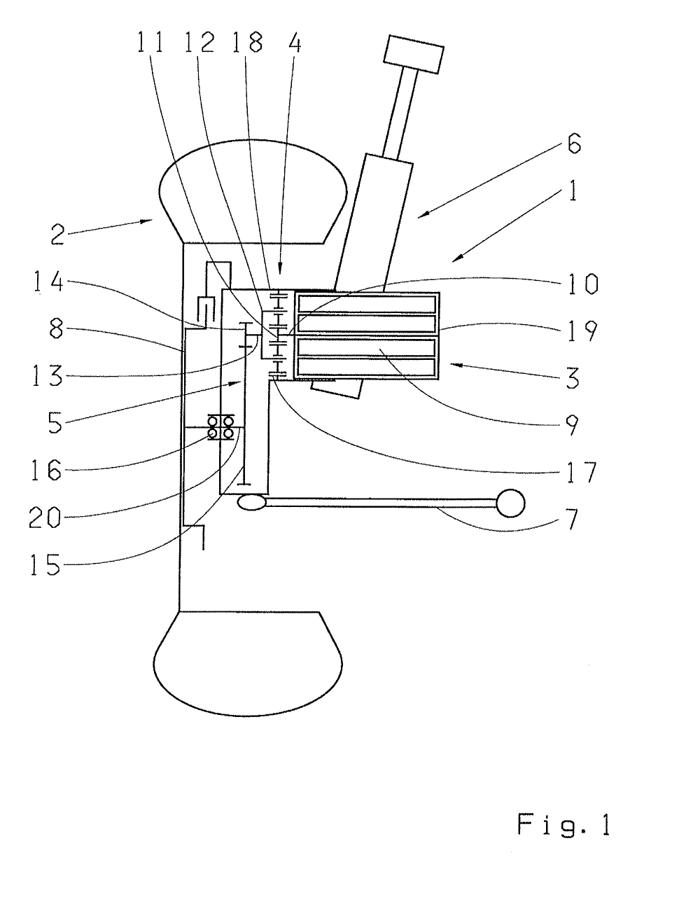

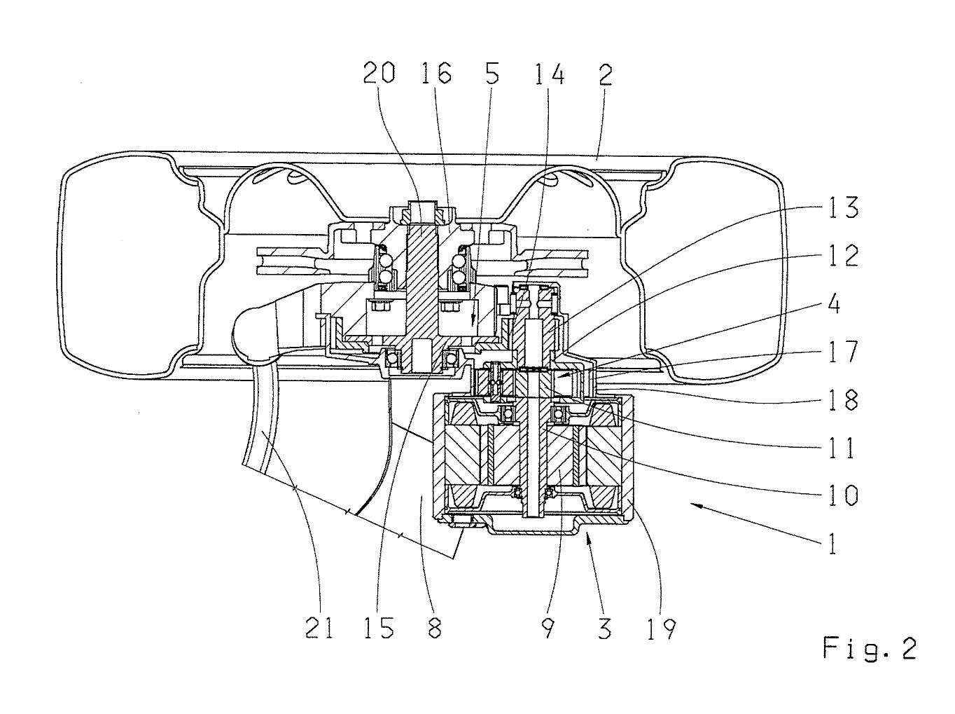

With reference to FIG. 1 and FIG. 2, a drive device 1 for driving a wheel 2 of a spring strut axle of an electrically driven vehicle comprises of an electric machine 3 and a transmission unit, which comprises a spur gear transmission 5 and a planetary transmission 4 which, viewed in the direction of the flow of force in the traction operation, are positioned on the output side of the electric machine 3 in the sequence of planetary transmission 4-spur gear transmission 5. The planetary transmission 4 and the spur gear transmission 5 in the shown example are, when viewed axially, positioned on the side of the electric machine 3 which faces the wheel 2.

The damper of the spring strut axle is marked with the reference character 6 in FIG. 1, whereby the transverse control arm is marked with 7 and the wheel carrier with 8. Also, the steering tie rod is marked with the reference character 21 in FIG. 2.

In the shown example, the rotor 9 of the electric machine 3, which is designed as an inner rotor, is connected via a sun gear shaft 10 with the sun gear 11 of the planetary transmission 4, whereby the carrier 12 of the planetary transmission 4 is connected via a carrier shaft 13 with the pinion 14 (meaning with the small gear wheel) of the spur gear transmission 5, which meshes with the spur gear 15 (meaning with the large gear wheel).

Here, the spur gear 15 is preferably connected to the hub 16 of the wheel 2 by means of a spline connection or plug of a polygonal profile or executed in one piece with the wheel hub 16. The connection between the carrier shaft 13 and the pinion 14 is preferably axially and radially supported by roller bearings, slide bearings, or thrust washers.

In addition, the ring gear 17 of the planetary transmission 4 is fixed in position to the housing; it can be coupled to the housing 18 of the planetary transmission 4, it can be designed as one piece with the housing 18, or it can be a press-fit into the housing 18. In the case that the ring gear 17 is designed as one piece with the housing 18, a radial recess can be provided to compensate for a difference in diameter between the housing 18 and the ring gear 17.

Through the design of the ring gear 17 as a ring gear which can be pressed into a cylindrical housing, the material can be selected depending on the load, whereby this results in a reduction of the weight. Also, the planetary gear 4 and the electric machine 3 can have a common housing. In the shown example, the housing of the electric machine 3 is marked with the reference character 19.

In addition, the rotor shaft 9 of the electric machine 3 can be designed as one part with the sun gear shaft; also the carrier shaft 13 can be designed as one part with the pinion 14.

In the framework of additional embodiments, not shown here, the drive and/or the output of the planetary transmission 4 can each be achieved via an additional element of the planetary transmission 4.

The gearing is preferably designed for helical gears, whereby the bearing of the sun gear shaft 10 of the planetary transmission 4 is formed by the drive side bearing of the rotor 9 of the electric machine 3 so that the necessity of additional bearings can be omitted, whereby the bearing of the rotor 9 of the electric machine 3, which faces away from the sun gear 11 of the planetary transmission 4, can preferably be axially preloaded by a spring element.

Hereby, the helix angle of the sun gear 11 of the planetary transmission 4 is preferably opposite to the helix angle of the pinion 14 of the spur gear transmission 5. In addition, the direction of the helix angle of the sun gear 11 and the planetary transmission 4 and the pinion 14 of the spur gear transmission 5 has to be selected in such a way that the loads on the bearings of the drive device 1 are minimized. Thus, friction losses are minimized and a smaller dimensioning of the bearings is made possible. In an advantageous manner, the amount and the sign of the helix angle of the spur gear 15 can be selected in such a way that the loads can be accommodated by a conventional bearing.

Furthermore, the bearing of the drive 20 of the drive device 1, meaning a shaft 20, which is connected with the spur gear 15, is formed by the bearing of the wheel 2 which can be designed as a bearing in the conventional art, for instance as a two-row roller bearing or as a bearing comprising two single helix ball bearings with a contact angle between 15° and 60°. Wherein the number of bearings needed for the drive device can be advantageously reduced.

In accordance with the invention, the housing of the drive device 1, in particular in the case of an embodiment according to FIGS. 1 and 2, the housing 19 of the electric machine 4 is directly connected, preferably screwed together, with the wheel carrier 8 of the spring strut axle 1. Alternatively, the housing 19 of the electric machine 3 can be integrated with the wheel carrier 8 as a multi-part welded component, or can be designed with the wheel carrier 8 as one part. In addition, the electric machine 3 can be inserted like a cartridge into the wheel carrier which serves in this case as the common housing .

In the framework of a further embodiment of the invention, the connection of the brake caliper, in the case of a disc brake and/or the damper 6 and/or the spring, integrated with an enclosure of the drive device 1, in particular in the case of the embodiment in accordance with FIGS. 1 and 2 into the enclosure 19 of the electric machine 3, wherein the connecting screws for the fixing the brake caliper are at the same time the housing screws for attaching the drive device 1 to the wheel carrier 8 of the axle.

Thus, a compact construction is achieved and there is no necessity for separate parts which will result in a cost reduction.

In the framework of an embodiment of the invention which is not shown here, the electric machine 3 can also be used as a hollow shaft motor, meaning be designed as an internal rotor with a rotor 9 which is designed as hollow shaft, wherein the planetary transmission 4 is positioned at the electric machine 3 which is facing a way from the wheel 2, the spur gear transmission is positioned at the electric machine 3 which is facing the wheel 2, and the carrier shaft 13 of the planetary transmission 4 is brought through the cavity of the rotor 9 of the electric machine 3 to the pinion 14 of the spur gear transmission 5. In such an embodiment, the housing 18 of the planetary transmission 4 can for instance be directly connected with the wheel carrier 8 of the spring strut axle.

By swapping the position of the electric machine 3 and the planetary transmission 4, in comparison to the embodiment example as in FIGS. 1 and 2, the advantage is achieved that construction space becomes available in the area of the chassis longitudinal carrier which is used in deflections, because the housing 18 of the planetary carrier 4 can be designed with a smaller, outer diameter than the housing 19 of the electric machine 3.

The electric machine 3 of the drive device 1 can be designed as a synchronous machine, an externally excited or permanent magnet excited synchronous machine, or as transverse field machine, which offers a large flexibility.

Through the inventive concept, with a low unsuspended mass and a high power/weight ratio (kW/kg), quite a compact construction of the drive device can be realized.

The drive device presented here can also be combined with any axle types, for instance with a central arm axle, spring control arm axle, multi-link arm axle, spring strut axles (with or without an individual, bottom arm), or trapezoid arm axle.

In addition, the drive device has a low number of bearings and good accessibility, whereby with just little modification an existing vehicle axle can be integrated into the axle.

Also, the brake device for the wheels can be designed as disc brake or drum brake; the drive device can be designed as air cooled or fluid cooled, whereby the electric machine, the planetary transmission, and the power electronic can have a common cooling.

### REFERENCE CHARACTERS

1 Drive Device
2 Wheel
3 Electric Machine
4 Planetary Transmission
5 Spur Gear Transmission
6 Damper
7 Wishbone
8 Wheel Carrier
9 Rotor
10 Sun Gear Shaft of the Planetary Transmission 4
11 Sun Gear of the Planetary Transmission 4
12 Bar of the Planetary Transmission 4
13 Bar Shaft of the Planetary Transmission 4
14 Pinion
15 Spur Gear
16 Wheel Hub
17 Ring Gear of the Planetary Transmission 4
18 Housing of the Planetary Transmission 4
19 Housing of the Electric Machine 3
20 Output of the Drive Device 1
21 Track Rod

1-14. (canceled)

15. A drive device (1) for driving a wheel (2) of a spring strut axle of an electrically driven vehicle, the drive device comprising:
an electric machine (3), and
a transmission unit,
the transmission unit comprising a spur gear transmission (5) and a planetary transmission (4) which, viewed in a direction of a flow of force during traction operation, being positioned on an output side of the electric machine (3) in a sequence of the planetary transmission (4) and then the spur gear transmission (5).

16. The drive device (1) for driving the wheel (2) of the spring strut axle for the electrically driven vehicle according to claim 15, wherein a rotor (9) of the electric machine (3) is designed as inner rotor and is connected, via a sun gear shaft (10), with a sun gear (11) of the planetary transmission (4), a carrier (12) of the planetary transmission (4) is connected, via a carrier shaft (13), with a pinion (14) of the spur gear transmission (5), which meshes with a spur gear (15), which is either connected with a wheel hub (16) of the wheel (2), or is designed as single part with the wheel hub (16), and a ring gear (17) of the planetary transmission (4) is fixed in positioned to a housing.

17. The drive device (1) for driving the wheel (2) of the spring strut axle for the electrically driven vehicle according to claim 16, wherein a bearing of an output (20) of the drive device (1) is formed by a wheel bearing of the wheel (2).

18. The drive device (1) for driving the wheel (2) of the spring strut axle for the electrically driven vehicle according to claim 16, wherein at least one of the rotor (9) of the electric machine (3) is designed as one part with the sun gear shaft (10) and the carrier shaft (13) is designed as one part with the pinion (14).

19. The drive device (1) for driving the wheel (2) of the spring strut axle for the electrically driven vehicle according to claim 15, wherein the planetary transmission (4) and the spur gear transmission (5), when axially viewed, are positioned on a side of the electric machine (3) which faces the wheel (2).

20. The drive device (1) for driving the wheel (2) of the spring strut axle for the electrically driven vehicle according to claim 15, wherein the planetary transmission (4) is positioned on a side of the electric machine (3) which faces away from the wheel (2), and the spur gear transmission (5) is positioned on a side of the electric machine (3) which faces toward the wheel (2), and the electric machine (3) is an inner rotor motor and a rotor (9) thereof is a hollow shaft, and a carrier shaft (13) of the planetary transmission (4) passes through a cavity of the rotor (9) of the electric machine (3) to a pinion (14) of the spur gear transmission (5).

21. The drive device (1) for driving the wheel (2) of the spring strut axle for the electrically driven vehicle according to claim 15, wherein a housing (18, 19) of the drive device (1) is directly connected to a wheel carrier (8) of a spring strut.

22. The drive device (1) for driving the wheel (2) of the spring strut axle for the electrically driven vehicle according to claim 21, wherein the housing (18, 19) is one of screwed to the wheel carrier (8), integrated with the wheel carrier (8) as a multi-part welded component, and designed as one part with the wheel carrier (8).

23. The drive device (1) for driving the wheel (2) of the spring strut axle for the electrically driven vehicle according to claim 15, wherein an attachment of a brake caliper, in a case of at least one of a disc brake, a damper (6) and a spring, is integrated with a housing (18, 19) of the drive device (1).

24. The drive device (1) for driving the wheel (2) of the spring strut axle for the electrically driven vehicle according to claim 23, wherein connecting screws for securing the brake caliper are housing screws for attaching the drive device (1) to a wheel carrier (8) of the spring strut axle.

25. The drive device (1) for driving the wheel (2) of the spring strut axle for the electrically driven vehicle according to claim 15, wherein the electric machine has an output shaft that is rotatable at a high maximum rotational speed that is larger than 5,000 rpm and a ratio of the rotational speed of the output shaft of the electric machine with respect to a rotational speed of a wheel shaft, is larger than 10.

26. The drive device (1) for driving the wheel (2) of the spring strut axle for the electrically driven vehicle according to claim 15, wherein at least a majority of the drive device is positioned ahead of a center of the wheel with respect to a forward drive direction of the vehicle.

27. The drive device (1) for driving the wheel (2) of the spring strut axle for the electrically driven vehicle according to claim 15, wherein at least a majority of the drive device is positioned after a center of the wheel with respect to a forward drive direction of the vehicle.

28. The drive device (1) for driving the wheel (2) of the spring strut axle for the electrically driven vehicle according to claim 15, wherein at least a majority of the drive device is positioned at opposite track rods of a spring strut with respect to a center of the wheel.

29. The drive device (1) for driving the wheel (2) of the spring strut axle for the electrically driven vehicle according to claim 15, wherein the electric machine has an output shaft that is rotatable at a high maximum rotational speed that is between 6,000 rpm and 10,000 rpm and a ratio of the rotational speed of the output shaft of the electric machine with respect to a rotational speed of a wheel shaft, is between 14 and 17.

30. The drive device (1) for driving the wheel (2) of the spring strut axle for the electrically driven vehicle according to claim 15, wherein the electric machine has an output shaft that is rotatable at a high maximum rotational speed that is around 7,000 rpm and a ratio of the rotational speed of the output shaft of the electric machine with respect to a rotational speed of a wheel shaft, is around 16.

31. A drive device (1) for driving a wheel (2) of a spring strut axle of an electrically driven vehicle, the drive device comprising:
an electric machine (3), and
a transmission unit,
the transmission unit comprising a spur gear transmission (5) and a planetary transmission (4) which, viewed in a direction of a flow of force during traction operation, being positioned on an output side of the electric machine (3) such that the flow of force during traction operation flows from the electric machine (3), through the planetary transmission (4) and to the spur gear transmission (5).

32. A drive device for driving a wheel of a spring strut axle of an electrically driven vehicle, the drive device comprising:
an electric machine (3),
a planetary transmission (4), and
a spur gear transmission (5),
a rotor of the electric machine being continuously connected to and driving a sun gear of the planetary transmission,
a ring gear of the planetary transmission being continuously connected to a housing enclosing the planetary transmission (4) and the spur gear transmission (5),
a planetary carrier of the planetary transmission being continuously connected to and driving a pinion gear of the spur gear transmission,
a spur gear of the spur gear transmission meshing with and being driven by the pinion gear, and
the spur gear of the spur gear transmission being continuously connected to a wheel hub which supports the wheel of the spring strut axle.
